(19) United States
(12) Patent Application Publication
(10) Pub. No.: US 2019/0072014 A1
(43) Pub. Date: Mar. 7, 2019

(54) CONTAINER, AN INTERNAL COMBUSTION ENGINE, A VEHICLE AND A METHOD

(71) Applicant: Jaguar Land Rover Limited, Warwickshire (GB)

(72) Inventor: William Hutchins, Whitley (GB)

(21) Appl. No.: 16/117,332

(22) Filed: Aug. 30, 2018

(30) Foreign Application Priority Data
Sep. 4, 2017 (GB) 1714117.7
Sep. 4, 2017 (GB) 1714118.5

(51) Int. Cl. F01M 11/00; F01M 11/08

(52) U.S. Cl. CPC F01M 11/0004; F01M 11/08; B01D 45/16; F01M 2011/007; F01M 2011/0041

(57) ABSTRACT

A container for containing a liquid within a vehicle, an internal combustion engine comprising a container, a vehicle comprising a container and a method of directing flow of liquid are disclosed. The container comprises an outer wall configured to contain a liquid and a plurality of baffles configured to direct flow of the liquid within the container. The plurality of baffles define a pickup chamber, at least three outer chambers positioned adjacent to the pickup chamber and at least one respective gap for each said outer chamber to allow liquid flow from each outer chamber through the at least one respective gap into the pickup chamber. A directing means is configured to cause liquid flowing from each of the outer chambers to flow around a vertical axis within the pickup chamber.

### CROSS REFERENCE TO RELATED APPLICATIONS

This application claims priority to United Kingdom Patent Application No. GB 1714118.5, filed on 4 Sep. 2017 and United Kingdom Patent Application No. GB 1714117.7, filed on 4 Sep. 2017.

### TECHNICAL FIELD

The present disclosure relates to a container for containing a liquid, an internal combustion engine, a vehicle and a method. In particular, but not exclusively it relates to a container, an internal combustion engine, a vehicle and a method in a road vehicle such as a car.

Aspects of the invention relate to a container, an internal combustion engine, a vehicle and a method.

The present disclosure also relates to an oil sump for an internal combustion engine, an internal combustion engine, a vehicle and a method. In particular, but not exclusively it relates to an oil sump, an internal combustion engine, a vehicle and a method in a road vehicle such as a car.

Aspects of the invention relate to an oil sump, an internal combustion engine, a vehicle and a method.

### BACKGROUND

A number of different containers are provided in vehicles for containing a liquid for use in the operation of the vehicle. Examples of such containers include oil sumps, fuel tanks, urea tanks and coolant tanks. Liquid is extracted from the container via an outlet (or pickup) that is typically positioned centrally within the container. Liquid may slosh from side to side (or backwards and forwards) within the container, due to the container being tilted and/or accelerated, for example by braking or cornering of the vehicle. Occasionally the sloshing can cause the outlet to not be submerged, which prevents liquid from being extracted from the container, and therefore preventing optimal operation of the vehicle.

It is known to provide baffles (or internal walls) within such containers to resist sloshing, but problems caused by sloshing can still occur with known designs of baffles. It is therefore an aim of the present invention to provide an improved solution to the problem of sloshing in containers for containing a liquid in a vehicle.

Within an internal combustion engine, oil is pumped to various parts of the engine for the purposes of lubrication and collected in a sump for reuse. During use, oil droplets within the crankcase are hit by the rotating crankshaft and lower ends of connecting rods, which results in very small droplets being suspended in the air to form an oily mist. One problem resulting from this is that the impact of oil droplets on the crankshaft causes a loss of power of the engine.

Also, operation of the engine introduces blow-by gases into the air within the crankcase and consequently some air has to continuously be removed from the crankcase to maintain a required low pressure in the crankcase. To achieve this, air is withdrawn from the crankcase via a PCV (positive crankcase ventilation) valve and mixed with fresh air for use in combustion in the engine. It is known to have to use an oil separator, associated with the PCV valve, to separate oil from such air before it is used for combustion.

In addition, oil returning to a sump of an engine may contain relatively large quantities of air, and the effectiveness of such oil when reused is reduced when compared to air-free oil. In dry sump systems, it is known to separate air from the oil before the oil is reused but this requires the extraction of an oil and air mixture from the sump and the separation in an air oil separator.

It is an aim of the present invention to address disadvantages of the prior art.

### SUMMARY OF THE INVENTION

Aspects and embodiments of the invention provide a container, an internal combustion engine, a vehicle and a method as claimed in the appended claims.

According to an aspect of the invention there is provided a container for containing a liquid within a vehicle, the container comprising: an outer wall configured to contain a liquid; a plurality of baffles configured to direct flow of the liquid within the container, the plurality of baffles defining a pickup chamber, at least three outer chambers positioned adjacent to the pickup chamber and at least one respective gap for each said outer chamber to allow liquid flow from each outer chamber through the at least one respective gap into the pickup chamber; and a directing means configured to cause liquid flowing from each of the outer chambers to flow around a vertical axis within the pickup chamber.

This provides the advantage that whichever way a liquid flows within the container, caused by acceleration or gravity when the container is tilted, it results in liquid flowing from at least one of the outer chambers into the pickup chamber and circulating within the pickup chamber to maintain liquid at the liquid outlet.

In some embodiments the directing means is configured to cause liquid flowing from each of the outer chambers to flow around the axis of the pickup chamber in the same rotational direction.

This provides the advantage that liquid flowing into the pickup chamber adds to the momentum of the liquid circulating within the pickup chamber regardless of which outer chamber the liquid flows in from.

The term “rotational direction” as used herein means a clockwise direction or counterclockwise direction.

In some embodiments the rotational direction is clockwise.

In some embodiments the directing means comprises at least three of the plurality of baffles.

In some embodiments at least a portion of each one of a first plurality of the baffles extends from a respective first position that is adjacent to the outer wall to a respective second position; the first position of each one of the first plurality of baffles is closer to the outer wall than the respective second position; and the directing means comprises at least a portion of each one of a second plurality of baffles that extend around the pickup chamber in the same rotational direction. This provides the advantage that the fluid flow from the outer chambers to the pickup chamber is relatively unimpeded, while fluid flow from the pickup chamber is resisted by the rotational flow of fluid within the pickup chamber.

In some embodiments each one of the second plurality of baffles is different to each one of the first plurality of baffles; and the second plurality of baffles form a ring of louvres surrounding the pickup chamber.

In some embodiments at least a first portion of each one of a first plurality of the baffles extends from a respective first position to a respective second position that is adjacent to the pickup chamber; the first positions are closer to the outer wall than the respective second positions; the directing means comprises a second portion of each one of the first plurality of baffles; and said second portions of the first plurality of baffles extend around the pickup chamber in the same rotational direction.

In some embodiments all of the second portions of the first plurality of baffles extend along a curve around the pickup chamber in the same rotational direction. This provides the advantage that the portions provide relatively little resistance to rotational flow within the pickup chamber.

In some embodiments each of the gaps is positioned relative to the pickup chamber to provide a course through the gap to one side of the vertical axis of the pickup chamber. This provides the advantage that liquid flowing along the course into the pickup chamber will be caused to circulate within the pickup chamber.

In some embodiments an end portion of each of the baffles extends around the pickup chamber. This provides the advantage that it facilitates a circulation of flow within the pickup chamber.

In some embodiments the container forms at least a portion of an oil sump, a fuel tank, a urea tank or a coolant tank for a vehicle.

In some embodiments the container comprises a liquid outlet positioned within the pickup chamber for enabling liquid to be drawn from the container.

In some embodiments the container provides an oil sump, or a portion of an oil sump, for an internal combustion engine.

In some embodiments an inlet of an air pickup tube is positioned in the pickup chamber of the container, and the air pickup tube is arranged to draw air from the pickup chamber. This provides the advantage that air that is relatively free of oil droplets may be extracted from the engine.

In some embodiments the air pickup tube is arranged to provide air to a positive crankcase ventilation (PCV) valve. This provides the advantage that air that is relatively free of oil droplets may be supplied to the PCV valve.

In some embodiments the container comprises a cover wall, and the cover wall comprises slots arranged to enable passage of oil and air into each one of the outer chambers.

In some embodiments at least one of the slots has an associated surface configured to deflect, towards the pickup chamber, air that flows through the at least one of the slots. This provides the advantage that oil particles carried by the air are directed towards the pickup chamber where they may be separated from the air.

In some embodiments the associated surface is provided by a scoop located within one of the outer chambers.

According to a further aspect of the present invention there is provided an internal combustion engine comprising a container according to any one of the previous paragraphs.

In some embodiments the internal combustion engine comprises a plurality of bays, and the cover wall is positioned below the bays, so that each one of the outer chambers is arranged to receive oil and air from a respective one of the bays via at least one of the slots. This provides the advantage that bay-to-bay breathing is provided through the oil sump and the energy provided by the bay-to-bay breathing may be used within the sump to separate oil from the air.

According to yet another aspect of the present invention there is provided a vehicle comprising a container according to any one of the previous paragraphs or an internal combustion engine according to any one of the previous paragraphs.

According to a yet further aspect of the present invention there is provided a method of directing flow of liquid contained within a container of a vehicle, in which the container comprises a plurality of baffles configured to direct flow of the liquid within the container, the plurality of baffles defining a pickup chamber, at least three outer chambers positioned adjacent to the pickup chamber and at least one respective gap for each said outer chamber to allow liquid flow from each outer chamber through the at least one respective gap into the pickup chamber, wherein the method comprises: causing liquid to flow alongside at least one of a plurality of baffles from at least one of three or more outer chambers of the container into the pickup chamber; directing liquid flowing from at least one of the outer chambers around a vertical axis of the pickup chamber; and pumping the liquid from the pickup chamber.

This provides the advantage that a flow of liquid within the container, caused by acceleration or gravity when the container is tilted, results in liquid flowing from at least one of the outer chambers into the pickup chamber and circulating within the pickup chamber to maintain liquid at the liquid outlet.

In some embodiments each of the plurality of baffles has a portion extending along a curve surrounding the pickup chamber, and the liquid flowing into the pickup chamber is caused to flow within the pickup chamber alongside said portions of the baffles, so that the liquid rotates around the pickup chamber.

In some embodiments each of the outer chambers is defined by two neighboring ones of the baffles.

In some embodiments the gaps are positioned to cause the flow of liquid to rotate around the pickup chamber.

In some embodiments the method comprises causing a flow of liquid through the gaps to meet at a tangent to a flow of liquid rotating around the pickup chamber.

In some embodiments the container is an oil sump of an internal combustion engine, and the method comprises drawing air through a tube from the pickup chamber.

In some embodiments the method comprises providing the air drawn from the pickup chamber to a positive crankcase ventilation (PCV) valve.

In some embodiments the method comprises causing oil and air to flow through slots in a cover wall of the oil sump into each one of the outer chambers.

In some embodiments the internal combustion engine comprises a plurality of bays; and the method comprises causing oil and air to flow from each of the bays through a respective slot in the cover wall of the oil sump into a respective one of the outer chambers.

According to yet another aspect of the invention there is provided a container for containing a liquid within a vehicle, the container comprising: an outer wall configured to contain a liquid; a plurality of baffles configured to direct flow of the liquid within the container, the plurality of baffles defining a pickup chamber for containing a liquid outlet, and at least three outer chambers positioned adjacent to the pickup chamber; and a directing means configured to cause liquid flowing from each of the outer chambers to flow around a vertical axis within the pickup chamber.

According to yet a further aspect of the invention there is provided a provided a container for containing a liquid within a vehicle, the container comprising: an outer wall configured to contain a liquid; a plurality of baffles configured to direct flow of the liquid within the container, the plurality of baffles defining a pickup chamber, at least three outer chambers positioned adjacent to the pickup chamber and at least one respective gap for each said outer chamber to allow liquid flow from each outer chamber through the at least one respective gap into the pickup chamber; and at least three of the baffles configured to cause liquid flowing from each of the outer chambers to flow around a vertical axis of the pickup chamber.

Aspects and embodiments of the invention provide an oil sump, an internal combustion engine, a vehicle and a method.

According to an aspect of the invention there is provided an oil sump for an internal combustion engine, the oil sump comprising: a plurality of baffles configured to direct flow of oil within the oil sump, the plurality of baffles defining a plurality of outer chambers and a pickup chamber; and a cover wall comprising a plurality of slots for enabling flow of air and oil into the oil sump; wherein the slots are positioned to enable an airflow into each one of the outer chambers and at least one of the slots is provided with a surface configured to redirect the airflow along a respective outer chamber to the pickup chamber.

This provides the advantage of assisting flow of oil and air to the pickup chamber and consequently assists the separation of oil and air within the sump.

In some embodiments at least one of the slots is provided with a respective scoop providing the surface for redirecting an airflow passing through said at least one of the slots; and/or a first one of the slots has a longitudinal axis extending along a first direction and a second one of the slots has a longitudinal axis extending along a second direction at an oblique angle to the first direction.

In some embodiments a respective gap is provided between neighboring ones of the baffles to allow a flow of oil from each of the outer chambers to the pickup chamber and the gaps are positioned to cause a rotating flow of air and/or oil around the pickup chamber. This provides the advantage of assisting the separation of oil and air within the sump.

In some embodiments the oil sump comprises a directing means configured to cause air and/or oil flowing from each of the outer chambers into the pickup chamber to flow around a vertical axis within the pickup chamber in the same rotational direction. This provides the advantage of assisting the separation of oil and air within the sump.

In some embodiments the directing means comprises at least three of the plurality of baffles.

In some embodiments the directing means comprises at least a portion of each one of at least some of the baffles, and all said portions extend around the pickup chamber in the same rotational direction.

In some embodiments the plurality of baffles is configured to enable air and oil to flow from each of the outer chambers to the pickup chamber, and the cover wall comprises a respective slot for each one of the outer chambers to enable passage of oil and air from outside of the oil sump into the respective outer chamber.

In some embodiments the oil sump has an outer wall; each one of a first plurality of the baffles extends from a respective first position to a respective second position; the first positions are closer to the outer wall than the respective second positions; and at the second positions the baffles extend around the pickup chamber in the same rotational direction. This provides the advantage of baffles configured to cause rotational flow of fluid within the pickup chamber for separating oil and air.

The term “rotational direction” as used herein means a clockwise direction or counterclockwise direction.

In some embodiments each of the second positions is at or adjacent to the pickup chamber.

In some embodiments the rotational direction is clockwise.

In some embodiments an end portion of each of the first plurality of baffles curves around the pickup chamber. This provides the advantage of providing lower resistance to a circulating flow within the pickup chamber and therefore assists separation of air and oil.

In some embodiments an end portion of each of the baffles extends circularly around the pickup chamber. This provides the advantage of providing lower resistance to a circulating flow within the pickup chamber and therefore assists separation of air and oil.

In some embodiments the cover wall provides a windage tray for an internal combustion engine.

According to another aspect of the invention there is provided an internal combustion engine comprising an oil sump according to any one of the previous paragraphs. In some embodiments the internal combustion engine comprises an oil outlet positioned within the pickup chamber for drawing oil from the oil sump.

In some embodiments the internal combustion engine comprises an air pickup tube arranged to provide air to a positive crankcase ventilation (PCV) valve, and the air pickup tube has an inlet positioned within the pickup chamber of the oil sump. This provides the advantage that air extracted from the engine and provided to the PCV valve is relatively free of oil without any further oil separation process being required.

In some embodiments the internal combustion engine comprises a plurality of bays, wherein each one of the outer chambers is associated with a respective one of the bays, and a respective one of the slots in the cover wall enables an airflow from each of the bays to the associated one of the outer chambers. This provides the advantage that bay-to-bay breathing may be used to cause a flow of air through the sump to assist separation of oil and air.

According to another aspect of the invention there is provided a vehicle comprising an internal combustion engine according to any one of the previous paragraphs.

According to a further aspect of the invention there is provided a method of directing a flow of oil through an oil sump, the method comprising: enabling air and oil to flow into each one of a plurality of outer chambers of an oil sump via slots, the outer chambers being defined by baffles; enabling air and oil to flow from the outer chambers to a pickup chamber of the oil sump; and pumping oil from the pickup chamber; wherein air passing through at least one of the slots is redirected by a surface to assist a flow of oil in a respective outer chamber towards the pickup chamber.

In some embodiments the air passing through the at least one of the slots is redirected by the surface provided on a scoop.

In some embodiments the method comprises causing air and/or oil flowing from each of the outer chambers into the pickup chamber to flow around a vertical axis within the pickup chamber in the same rotational direction. This provides the advantage of assisting the separation of oil and air within the sump.

In some embodiments a respective gap is provided between neighboring baffles to allow the flow of oil from each of the outer chambers to the pickup chamber.

In some embodiments the method comprises causing air and/or oil flowing from each of the outer chambers into the pickup chamber to flow around a vertical axis within the pickup chamber in the same rotational direction by baffles positioned within or adjacent to the gaps.

In some embodiments the gaps are positioned to cause a rotating flow of air and/or oil around the pickup chamber.

In some embodiments the method comprises drawing air from the pickup chamber into a positive crankcase ventilation (PCV) valve.

In some embodiments each of the baffles is positioned to extend from a respective first position to a respective second position, so that the first position of each baffle is closer to the outer wall than the respective second position and at the second positions the baffles extend around the pickup chamber in the same rotational direction.

In some embodiments end portions of the baffles are positioned to define the pickup chamber and to curve around the pickup chamber.

In some embodiments the slots are configured to enable a flow of air and oil from each bay of an internal combustion engine to a respective one of the outer chambers of the oil sump, and the method comprises causing air to flow into and out of the slots by bay-to-bay breathing.

In some embodiments the method comprises causing air to flow: from a first one of the bays of an internal combustion engine, through a first one of the outer chambers to the pickup chamber; and from the pickup chamber through a second one of the outer chambers to a second one of the bays.

According to another aspect of the invention there is provided an oil sump of an internal combustion engine, the oil sump comprising: a cover wall comprising a plurality of slots for enabling passage of air and oil from above the cover wall into the oil sump; and an outlet for drawing oil from the oil sump; wherein at least one of the slots has a surface oriented to redirect air flowing into the sump from a first direction to a second direction having a component directed towards the outlet.

According to another aspect of the invention there is provided a windage tray for an internal combustion engine, the windage tray comprising a plurality of slots to enable a flow of oil and air into an oil sump, wherein at least one of the slots is provided with a respective scoop for redirecting a flow of air passing through said at least one of the slots and/or a first one of the slots has a longest dimension extending along a first direction and a second one of the slots has a longest dimension extending along a second direction at an oblique angle to the first direction. This provides the advantage that, during use within an internal combustion engine, air passing through the slots may be redirected along an outer chamber of a sump towards a pickup chamber where the oil is withdrawn.

According to another aspect of the invention there is provided an internal combustion engine comprising a plurality of bays, each said bay containing a connecting rod of a piston, and an oil sump, the oil sump comprising: a plurality of baffles defining a plurality of outer chambers and a pickup chamber configured to receive flows of air and oil from the outer chambers; a cover wall comprising a plurality of slots for enabling flows of air and oil into the oil sump; and an oil outlet positioned within the pickup chamber for drawing oil from the oil sump; wherein a respective one of the slots is positioned to enable an airflow into each one of the outer chambers from a respective one of the bays of the engine, to provide bay-to-bay breathing via the pickup chamber. This provides the advantage that, during use, the bay-to-bay breathing may be used to cause flows of fluid in the sump that assists separation of oil and air.

According to a further aspect of the invention there is provided method of directing a flow of oil through an oil sump, the method comprising: enabling air and oil to flow from each bay of an internal combustion engine into a respective one of a plurality of outer chambers of an oil sump via a respective slot; causing a rotating motion of air and oil in a pickup chamber of the sump by enabling air and oil to flow from the outer chambers to the pickup chamber; and pumping oil from the pickup chamber.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle comprising four containers;

FIG. 2 shows a plan view of a container embodying the present invention;

FIG. 3 shows a perspective view of the container of FIG. 2;

FIGS. 4 and 5 show a cross-sectional view of the container in a level orientation and a tilted orientation respectively;

FIGS. 6, 7 and 8 show alternative containers embodying the present invention;

FIG. 9 shows an internal combustion engine comprising an oil sump embodying the present invention;

FIGS. 10 and 11 show a plan view and cross-sectional view of the sump of FIG. 9;

FIG. 12 shows a cross-section of an alternative oil sump embodying the present invention;

FIG. 13 shows flows around the baffles of the sump in the vicinity of the pickup chamber during downward strokes of two pistons of the engine of FIG. 9;

FIG. 14 shows flows around the baffles of the sump in the vicinity of the pickup chamber during downward strokes of two other pistons of the engine of FIG. 9;

FIGS. 15 and 16 show a partial cross-sectional view of the sump in the vicinity of one of the slots in a cover wall of the oil sump during a downward stroke of a piston and an upward stroke of the same piston; and

FIG. 17 shows a cross-sectional plan view of another alternative container 201D embodying the present invention.

### DETAILED DESCRIPTION

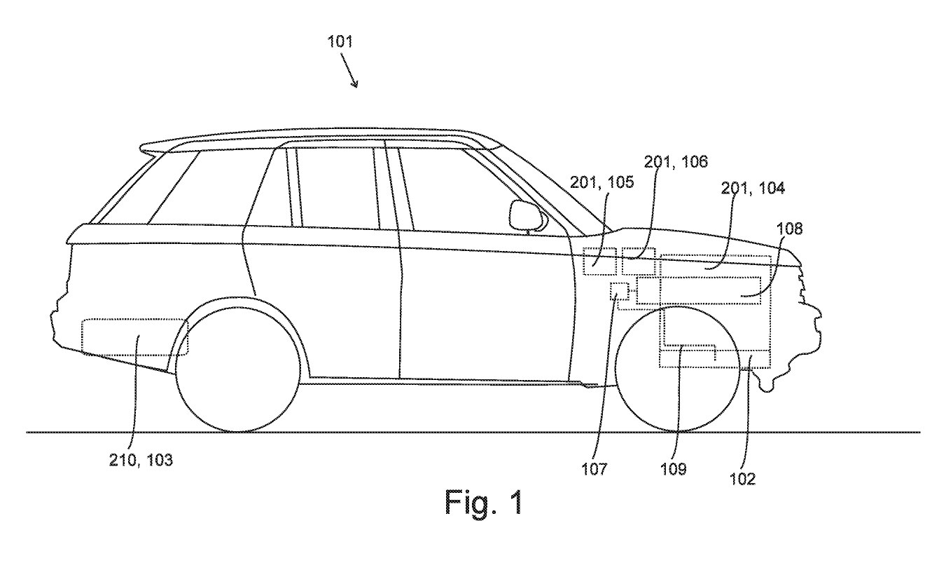

A vehicle 101 is shown in FIG. 1 which comprises four containers 201 for containing a liquid. The first of the four containers 201 is an oil sump 102 that is positioned at the lower end of an internal combustion engine 104 (referred to below simply as “engine 104”) and the second container 201 is a fuel tank 103. The third container 201 is a tank 105 for containing urea and the fourth container 201 is a tank 106 for containing coolant.

In order to maintain a required low pressure within the crankcase of the engine 104, air is extracted from the crankcase via a PCV (positive crankcase ventilation) valve 107 to the air intake manifold 108 of the engine 104. In one embodiment, air supplied to the PCV valve 107 is extracted from the sump 102, via a passageway 109, as will be described further below, with reference to FIG. 12.

In the present embodiment, the vehicle 101 is a car but in alternative embodiments the vehicle 101 is another type of road vehicle or a vehicle that is not for road use, such as a boat.

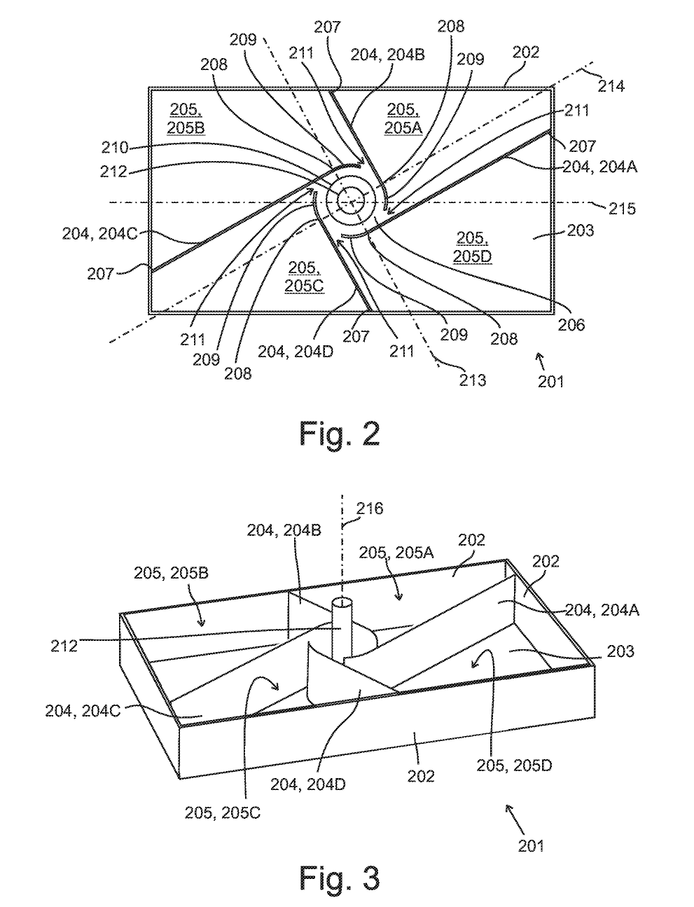

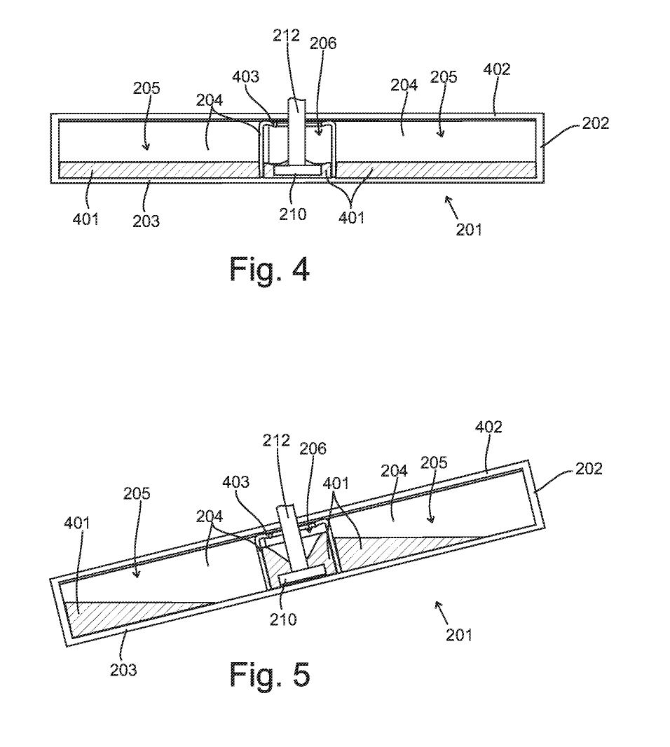

A container 201 for containing a liquid within a vehicle 101 is illustrated in a plan view in FIG. 2 and in a perspective view in FIG. 3. In FIGS. 2 and 3 a cover wall (402 in FIG. 4) of the container 201 has been removed to illustrate the interior of the container 201 more clearly. The container 201 may provide the oil sump 102, the fuel tank 103, the urea tank 105 or the coolant tank 106 of FIG. 1.

The container 201 comprises a lower wall 203 and an outer wall 202 extending up from the lower wall 203, to contain a liquid. In the example of FIGS. 2 and 3 the outer wall 202 meets the lower wall 203 at an edge, but it will be appreciated that in alternative embodiments the container 201 may have a shape in which the outer wall 202 and the lower wall 203 form parts of a continuous curved surface. Furthermore, the lower wall 203 may be shaped, for example dished.

The container 201 comprises a plurality of baffles 204 configured to direct flow of liquid within the container 201. In the present embodiment, the container has four baffles 204A, 204B, 204C and 204D, but in other embodiments, the container has only 3 baffles or has 5 or more baffles. The baffles 204 are internal walls of the container 201 that extend upwards from the lower wall 203 to the cover wall (402 in FIG. 4), or to an upper edge of the baffles 204 that is adjacent to the cover wall.

The baffles 204 define a plurality of outer chambers 205 and a pickup chamber 206. A first of the outer chambers 205A is bounded by the outer wall 202 of the container 201 and the baffles 204A and 204B. Similarly, each of the other outer chambers 205 is bounded by the outer wall 202 and a pair of the baffles 204. Thus, the outer chamber 205B is bounded by baffles 204B and 204C, the outer chamber 205C is bounded by baffles 204C and 204D, and the outer chamber 205D is bounded by baffles 204D and 204A.

Each of the baffles 204 extends from a respective first position 207 to a respective second position 208, the first position 207 of each baffle being closer to the outer wall 202 than the respective second position 208. From their respective second positions 208, end portions 209 of the baffles 204 extend along a curve around the pickup chamber 206 in the same rotational direction. In the present embodiment, when viewed from above, as shown in FIG. 2, the end portions 209 of the baffles 204 extend in a clockwise direction from their respective second positions 208. However, in alternative embodiments, for example, where the arrangement of the baffles appears to be a mirror image of those in FIG. 2, the end portions 209 of the baffles 204 extend anticlockwise from their second positions 208 when viewed from above.

A liquid outlet 210 at one end of a pickup tube 212 is positioned within the pickup chamber 206 for enabling liquid to be pumped from the container 201. For example, in an embodiment in which the container 201 forms a fuel tank 103, the outlet 210 is provided by a pickup tube 212 that draws fuel from the tank 103. The outlet 210 is positioned at the lower end of the pickup chamber 206 and centrally within the pickup chamber 206, so that liquid is able to flow freely around the outlet 210 within the pickup chamber 206.

In the present embodiment, the baffles 204 butt up to the outer wall 202, but in alternative embodiments a small gap may be provided between an outer edge of each baffle 204 and the outer wall 202.

A gap 211 is provided between an end of the end portions 209 of each of the baffles 204 and a neighboring baffle 204. For example, a gap 211 is provided between the end portion 209 of the baffle 204B and the baffle 204A, and similarly another gap 211 is provided between the end portion 209 of the baffle 204C and the baffle 204B. The gaps 211 provide a passageway for enabling liquid within the container 201 to flow from the outer chambers 205 to the pickup chamber 206.

Each of the baffles 204 extends away from the outer wall 202 towards the pickup chamber 206 and neighboring baffles 204. Therefore, when liquid is present within the container 201 and flowing from an outer chamber 205 to the pickup chamber 206, it is funneled by neighboring baffles 204 through the respective gap 211 into the pickup chamber 206. The baffles 204 are shaped to cause liquid entering the pickup chamber 206 to flow to one side of a vertical axis 216 (shown in FIG. 3) of the pickup chamber 206 to cause the liquid to circulate within the pickup chamber 206. In the present embodiment, the baffles 204 are shaped to cause the liquid entering the pickup chamber 206 through any one of the gaps 211 to flow to the left of the vertical axis 216 of the pickup chamber 206 to cause a clockwise flow of liquid within the pickup chamber 206. Thus, it will be understood that the end portions 209 of the baffles 204 provide a directing means configured to cause fluid flowing from each of the outer chambers 205 to flow around the axis 216 of the pickup chamber 206.

As liquid flows through a gap 211 into the pickup chamber 206 it flows alongside the baffle 204 on its left and is directed clockwise around the outlet 210 by the curved end portion 209 of that baffle 204 and the end portions 209 of each of the other baffles 204.

In the present embodiment, the end portions 209 of each of the baffles 204 extend circularly around the pickup chamber 206. Also, the end portions 209 of the baffles 204 and adjoining portions of the baffles 204 at the second positions 208 define a smooth surface facing the pickup chamber 206, so that liquid flowing through a gap 211 into the pickup chamber 206 is able to join a flow of liquid circulating within the pickup chamber 206 substantially at a tangent to the flow. Thus, liquid is able to enter the pickup chamber 206 relatively easily.

However, when liquid is circulating around the outlet 210 within the pickup chamber 206, it cannot easily flow out of the pickup chamber 206 into an outer chamber 205 because this would require a sudden change in direction of the liquid in order to flow through one of the gaps 211. One advantageous effect of this is illustrated in the cross-sectional views of FIGS. 4 and 5 in which the container 201 is shown in a level orientation and a tilted orientation respectively, and containing a small amount of liquid 401.

In the example shown in FIG. 4, the container 201 is horizontally positioned, and liquid 401 within the container 201 has an upper surface that is substantially flat and level. This scenario may occur, for example, in the fuel tank 103 when the vehicle 101 is travelling at a constant velocity over a level road. The outlet 210 is submerged in liquid 401 and liquid may therefore be pumped out through the outlet 210.

In FIG. 5, the container 201 is tilted so that liquid 401 tends to flow towards the lowest end of the container 201. (This may occur when the vehicle 101 has begun travelling over sloping surface.) However, when such tilting occurs, liquid in an outer chamber 205 that is positioned above the pickup chamber 206 is directed, by the neighboring baffles 204 defining that outer chamber 205, through the respective gap 211 and, as described above, the liquid 401 is caused to flow around the outlet 210 within the pickup chamber 206 by the baffles 204. Also because the momentum of the liquid 401 circulating within the pickup chamber 206 resists flow through the gaps 211 out of the pickup chamber 206, the level of liquid 401 in the pickup chamber 206 rises. Consequently, the outlet 210 continues to be immersed in liquid 401, which enables liquid to continue to be drawn through the outlet 210.

It will also be appreciated that liquid may be caused to flow within the container 201 by acceleration of the vehicle, for example by the vehicle 101 increasing speed, braking and/or travelling around a bend. However, this situation is similar to that of FIG. 5; liquid 401 from at least one outer region 205 is caused to flow into the pickup chamber 206 by the acceleration and the baffles 204, and its flow from the pickup chamber 206 is resisted by the resulting circular flow within the pickup chamber 206. Consequently, not only is the liquid 401 prevented from sloshing from one end of the container 201 to the opposite end, but the circulating flow of the liquid within the pickup chamber 206 may also result in the outlet being temporarily immersed in an increased depth of liquid.

As the liquid circulates within the pickup chamber 206, its momentum causes the liquid to have a depth adjacent to the baffles 204 that is greater than the depth at the middle of the pickup chamber 206. The baffles 204 may have an upper edge that is sealed against a cover wall 402 of the container 201, but in some embodiments they may not have. In such embodiments, the upper edges of the baffles 204 may be provided with a flange 403 that extends inwards over the pickup chamber 206 and downwards to direct the liquid 401 back downwards into the pickup chamber 206 and prevent the liquid 401 from spilling over the upper edge of the baffles 204.

In the embodiment of FIGS. 2 and 3, the four baffles 204 are angularly separated around the outlet 210 by approximately ninety degrees, and the gaps 211 are similarly separated by approximately ninety degrees. Thus, it will be understood that, liquid 301 will flow from a particular one of the outer chambers 205 that depends upon the angle between the container 201 and the axis about which it is tilted. For example, if the container 201 is tilted about an axis 215 (shown in FIG. 2), so that the outer chamber 205C is raised, then fluid will flow from the outer chamber 205C alongside the baffle 204C through the respective gap 211 into the pickup chamber 206. The container 201 may be similarly tilted about various other horizontal axes over a range of 90 degrees between the illustrated axes 213 and 214, such that the outer chamber 205C is generally higher than the respective gap 211, and such tilting will also cause liquid to flow from the outer chamber 205C into the pickup chamber 206.

It will be appreciated that tilting the container 201 about any axis that causes any other outer chamber 205 to rise above the respective gap 211 leading to the pickup chamber 206 will similarly cause liquid to flow into the pickup chamber 206 from that outer chamber 205.

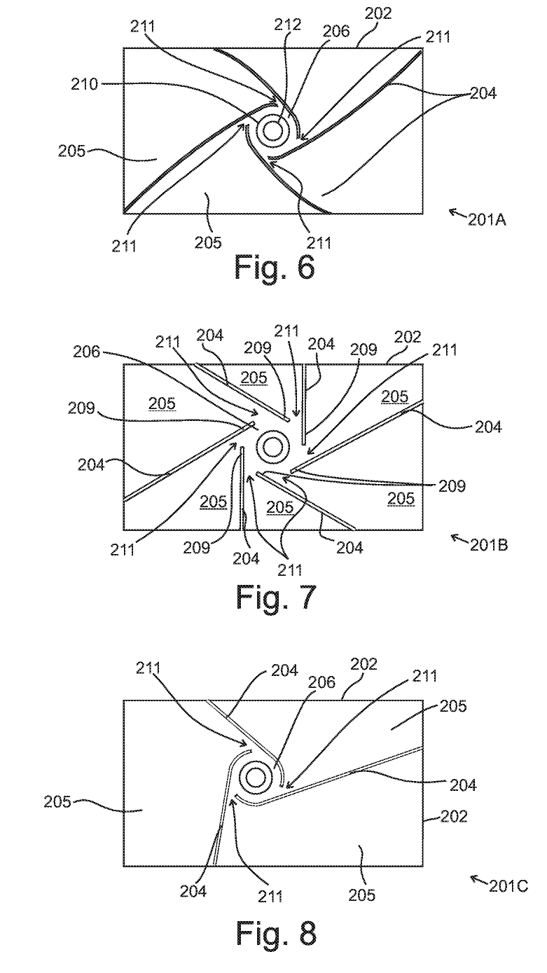

Alternative containers 201A, 201B and 201C embodying the present invention, suitable for containing a liquid within a vehicle 101 are illustrated in plan views in FIGS. 6 to 8. It should be understood that the containers 201A, 201B and 201C are similar to the container 201 of FIG. 2 but differ in the arrangement of their baffles 204. Thus, each of the containers 201A, 201B and 201C have baffles 204 that extend inwards from an outer wall 202 to a pickup chamber 206 that contains a liquid outlet 210 at one end of a pickup tube 212. Each of the baffles 204 of each of the containers 201A, 201B and 201C divides one outer chamber 205 from a neighboring outer chamber 205 and also partially separates each outer chamber 205 from the pickup chamber 206. A gap 211 is provided between each baffle 204 and a neighboring baffle 204 to provide access from the outer chambers 205 to the pickup chamber 206.

The container 201A of FIG. 6 differs from the container 201 of FIG. 2 in that the baffles 204 are curved along their entire length from where they meet the outer wall 202 to their opposite ends where they define a gap 211. In contrast, the baffles 204 of FIG. 2 have substantially straight portions extending between the outer wall 202 and the curved end portions 209.

The container 201B of FIG. 7 differs from the container 201 of FIG. 2, in that it has six baffles 204 rather than four. The six baffles 204 are angularly separated around the outlet 210 by approximately sixty degrees. Whichever way the container of FIG. 7 is tilted, liquid in the container 201B will generally flow from at least two of the outer chambers 205 into the pickup chamber 206. In an embodiment, each of the six baffles 204 has a curved end portion in a similar manner to the baffles 204 of the container of FIG. 2, but in the present embodiment, the baffles 204 have straight end portions 209 and the baffles 204 are all straight. However, it will be appreciated that the obtuse angle defined between adjacent ones of the baffles 204 enables liquid flowing clockwise within the pickup chamber 206 to be retained within the pickup chamber 206.

The container 201C of FIG. 8 differs from the container 201 of FIG. 2 in that it has just three baffles 204 separating the three outer chambers 205 from each other. Also, unlike previous embodiments, the baffles 204 define a pickup chamber 206 that is not positioned centrally within the outer wall 202. However, the outlet 210 of the container 201C is positioned centrally within the pickup chamber 206. The three baffles 204 are angularly separated around the outlet 210 by approximately 120 degrees.

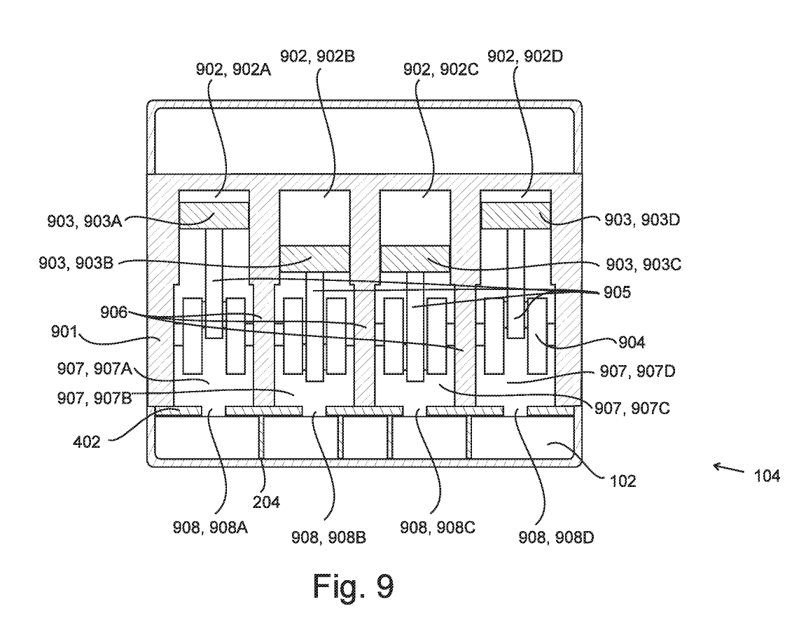

The internal combustion engine 104 comprising the oil sump 102 is illustrated in a somewhat schematic cross-sectional view in FIG. 9. In the present embodiment, the engine 104 comprises four cylinders 902, each containing a respective piston 903. Thus, cylinder 902A contains a piston 903A, cylinder 902B contains a piston 903B, cylinder 902C contains a piston 903C, and cylinder 902D contains a piston 903D. Each cylinder 902 in combination with its respective piston 903 defines a combustion chamber.

Each of the pistons 903 is connected to a crankshaft 904 by a respective connecting rod 905. The crankshaft 904 is located within a crankcase 901 and it is supported by front and rear main bearings and also by intermediate bearings located within internal walls 906, which divide space within the crankcase 901 into four separate bays 907. During operation of the engine 104, the bays 907 contain air that is contaminated with blow-by gases escaping from the combustion chambers and droplets of oil used to lubricate moving parts of the engine 104. For the purposes of the present specification the mixture of air, blow-by gases and oil droplets will simply be referred to as “air”.

The interior of the sump 102 is separated from the bays 907 by a cover wall 402 of the sump 102, which provides a windage tray for the engine 104, and which provides an end wall of the bays 907.

During operation of the engine 104, the reciprocating motion of the pistons 902 causes the volume of each of the bays 907 to repeatedly change. To avoid compression of the air within the bays 907, passageways may be provided between neighboring bays 907 through the internal walls 906. However, in the present embodiment, bay-to-bay breathing is provided via the oil sump 102 by slots 908 formed in the cover wall 402 of the sump 102. One or more slots 908 are provided in the cover wall 402 at the lower end of each one of the bays 907. I.e., in the present embodiment, in which the engine has four bays 907, one or more slots 908A are positioned at the end of a first bay 907A, one or more slots 908B are positioned at the end of a second bay 907B, one or more slots 908C are positioned at the end of a third bay 907C, and one or more slots 908D are positioned at the end of a fourth bay 907D.

During operation, the pistons 903A and 903D are lowered, decreasing the volume of the first bay 907A and the fourth bay 907D, and the pistons 903B and 903C are simultaneously raised, increasing the volume of the second bay 907B and the third bay 907C. This causes air to be forced through the first slot(s) 908A and the fourth slot(s) 908D allowing air to escape from the first and fourth bays, 907A and 907D, into the sump 102 and out through the second slot(s) 908B and the third slot(s) 908C into the second and third bays, 907B and 907C. Subsequently, as the pistons 903B and 903C are lowered, decreasing the volume of the second bay 907B and the third bay 907C, and the pistons 903A and 903D are simultaneously raised, increasing the volume of the first bay 907A and the fourth bay 907D, air is forced through the second slot(s) 908B and the third slot(s) 908C allowing air to escape from the second and third bays, 907B and 907C, into the sump 102 and out through the first slot(s) 908A and fourth slot(s) 908D into the first and fourth bays, 907A and 907D.

In this manner air is pumped from the bays 907 backwards and forwards through the sump 102. The sump 102 comprises baffles 204 (illustrated schematically in FIG. 9) configured to cause the air pumped through the sump 102 to take a circuitous route that causes separation of the oil droplets from the air in which they are supported.

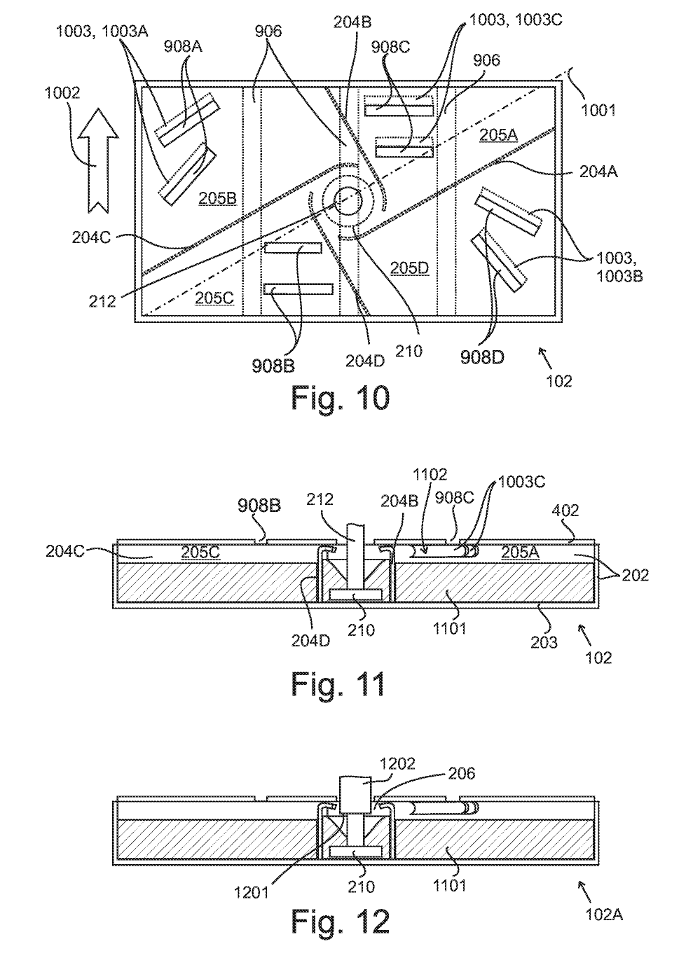

A plan view of the sump 102 is shown in FIG. 10 and a cross-sectional view of the sump 102 containing oil 1101 is shown in FIG. 11. The cross-section shown in FIG. 11 is along a plane 1001 shown in FIG. 10. The positions of the interior walls 906 of the engine 104 are illustrated by dashed lines in FIG. 10.

In the present embodiment, two slots 908 are provided in the cover wall 402 at the lower end of each of the four bays 907. In alternative embodiments, just one slot 908 is provided for each of the bays 907 or more than two slots are provided for each of the bays 907.

The oil sump 102 comprises four baffles 204 as described with regard to the container 201 shown in FIG. 2. Thus, a first baffle 204A separates a first outer chamber 205A of the sump 102 from a fourth outer chamber 205D of the sump 102; a second baffle 204B separates the first outer chamber 205A from a second outer chamber 205B of the sump 102; a third baffle 204C separates the second outer chamber 205B from a third outer chamber 205C of the sump 102; and a fourth baffle 204D separates the third outer chamber 205C from the fourth outer chamber 205D. In addition, end portions 209 of the baffles 204 define a pickup chamber 206 which contains an oil outlet 210 to enable oil to be pumped from the sump 102.

In the present embodiment, each outer chamber 205 is able to receive a flow of air (containing oil droplets) from the bays 907 via two respective slots 908. The slots 908 are positioned within the cover wall 402 so that each outer chamber 205 receives air from a respective one of the bays 907. In the present embodiment, the second outer chamber 205B receives air via the first slots 908A from the first bay 907A; the third outer chamber 205C receives air via the second slots 908B from the second bay 907B; the first outer chamber 205A receives air via the third slots 908C from the third bay 907C; and the fourth outer chamber 205D receives air via the fourth slots 908D from the fourth bay 907D.

During operation of the engine 104, oil is pumped out of the sump 102 through a pickup tube 212 via the outlet 210 in the pickup chamber 206. Consequently, oil flows from the outer chambers 205 through the gaps 211 into the pickup chamber 206. The direction of the oil as it enters the pickup chamber 206 is clockwise around the pickup chamber 206, which causes a continuous clockwise motion of oil within the pickup chamber 206.

A portion of the oil entering the pickup chamber 206 may be in the form of foam floating on the top of the bulk of the oil. The clockwise flow of the oil within the pickup chamber 206 has a centrifugal-type effect, in that the denser component of the foam, i.e. the oil, is forced towards the outside of the flow where it coalesces with the bulk of the oil, and the lighter component, i.e. air, is forced inwards towards the middle of the pickup chamber 206. Thus, the circular flow of oil within the pickup chamber 206 assists the removal of air from the oil before it is pumped around the engine 104.

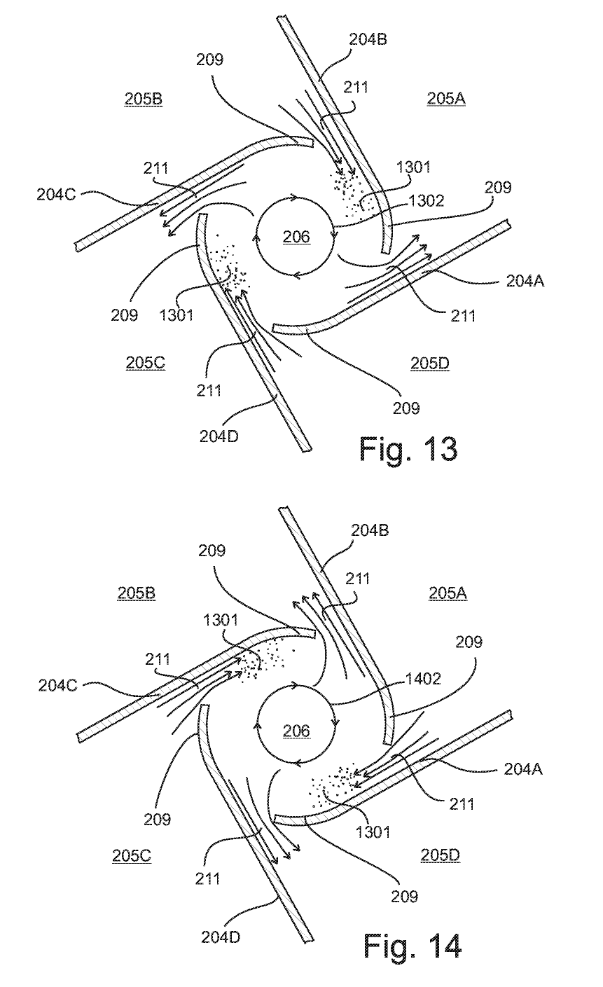

When the pistons 903A and 903D (shown in FIG. 9) are lowered, air is forced out of the bays 907A and 907D through slots 908A and 908D into the outer chambers 205B and 205D of the oil sump 102. Simultaneously, air is drawn into the bays 907B and 907C from the outer chambers 205C and 205A. Consequently, air is pumped through the pickup chamber 206 as illustrated in FIG. 13, which shows flows around the baffles 204 in the vicinity of the pickup chamber 206. Specifically, air containing oil droplets 1301 is forced through gaps 211 alongside baffles 204B and 204D from outer chambers 205B and 205D, while air is drawn out of the other gaps 211 alongside baffles 204A and 204C into the outer chambers 205A and 205C. The flows of air entering the pickup chamber 206 from outer chambers 205B and 205D are relatively focused and have a direction that is substantially in a clockwise direction around the pickup chamber 206. In contrast, the air entering the outer chambers 205A and 205C is drawn from the pickup chamber 206 over a wider range of angles. Consequently, the net flow of mass of air within the pickup chamber 206 is clockwise as in indicated by circular arrows 1302.

In addition, the relatively high momentum of the oil droplets 1301, compared to that of the air in which they are suspended, tends to cause the oil droplets to continue on a path past the gaps 211 that lead to the outer chambers 205A and 205C and to remain within the pickup chamber 206. Consequently, the air drawn out of the pickup chamber 206 into outer chambers 205A and 205C is relatively free of oil when compared to the air entering the pickup chamber 206 from outer chambers 205B and 205D.

Similarly, when the pistons 903B and 903C (shown in FIG. 9) are lowered, air is forced out of the bays 907B and 907C through slots 908B and 908C into the outer chambers 205C and 205A (shown in FIG. 10) of the oil sump 102. Simultaneously, air is drawn into the bays 907A and 907D from the outer chambers 205B and 205D as the pistons 903A and 903D are raised. Consequently, air is pumped through the pickup chamber 206 as shown in FIG. 14. Specifically, air containing oil droplets 1301 is forced through gaps 211 alongside baffles 204A and 204C from outer chambers 205A and 205C, while air is drawn out of the other gaps 211 alongside baffles 204B and 204D into the outer chambers 205B and 205D. The flows of air entering the pickup chamber 206 from outer chambers 205A and 205C are relatively focused and have a direction that is substantially in a clockwise direction around the pickup chamber 206. In contrast, the air entering the outer chambers 205B and 205D is drawn from the pickup chamber 206 over a wider range of angles. Consequently, the net flow of mass of air within the pickup chamber 206 is again clockwise as in indicated by circular arrows 1402.

Because the net airflow within the pickup chamber 206 is clockwise for both upward strokes and downward strokes of each piston 903, the oil droplets circulating within the pickup chamber 206 are able to attain high speeds and their momentum tends to force them outwards towards the surrounding wall of the pickup chamber 206, which is provided by the end portions 209 of the baffles 204. Oil droplets colliding with the baffles 204 or other oil droplets or the bulk of the oil within the pickup chamber 206 are able to coalesce with other droplets or the bulk of the oil. Also, because the oil droplets are forced outwards and removed from the circulating air, the air towards the middle of the pickup chamber 206 becomes relatively free of oil droplets.

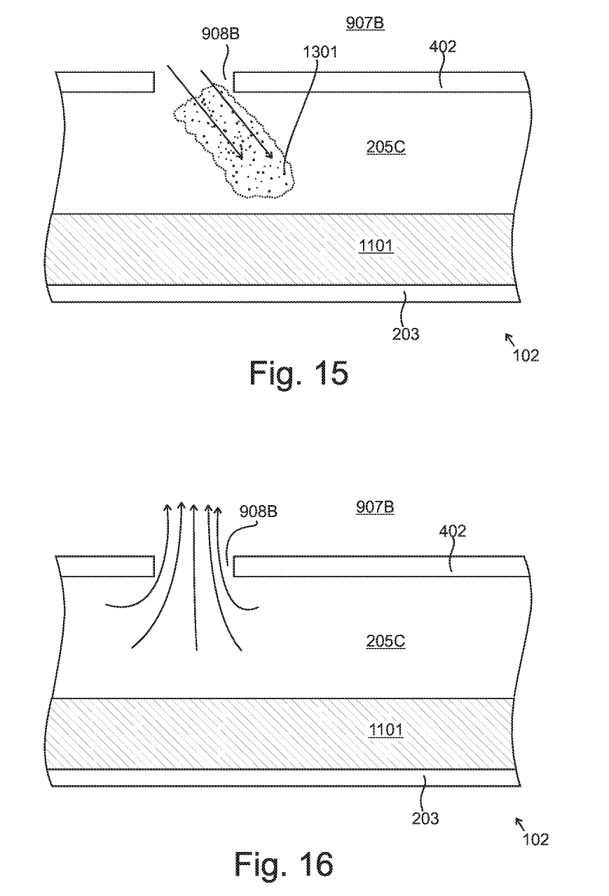

Another process by which the sump 102 separates oil droplets from the air in which they are suspended is illustrated in FIGS. 15 and 16. FIGS. 15 and 16 show a partial cross-sectional view of the sump 102 in the vicinity of one of the slots 908B during a downward stroke of the piston 903B and an upward stroke of the piston 903B respectively. During a downward stroke of the piston 903B, air (and oil droplets suspended in the air) is forced out of the bay 907B into the outer chamber 205C of the sump 102, as shown in FIG. 15. The oil droplets 1301 suspended in the air are carried away from the slot 908B until the down stroke of the piston 903B is completed and its upward stroke begins.

During the upward stroke of piston 903B air is drawn out from the outer chamber 205C of the sump 102 through the slot 908B and into the bay 907B.

The gaseous components of the air have relatively low density and therefore relatively low momentum when compared to the relatively dense oil droplets. Consequently, the gaseous components of the air are more easily able to change direction and be drawn back out through the slot 908B, whereas the velocity of the relatively dense oil particles is less easily changed. As a result, the air drawn out of the sump 102 comprises less oil than that which was blown into the sump 102.

This reduction in oil is further assisted by the manner in which air flows into and out of the sump 102. The air blown through the slot 908B tends to enter the sump 102 in a particular direction, as illustrated in FIG. 15, and so oil droplets are carried at relatively high speed for a relatively long distance away from the slot 908B before the piston 903B begins its upward stroke. In contrast, during the upward stroke of the piston 903B, air may be drawn from all around the slot 908B, as illustrated in FIG. 16, and therefore the air that was previously blown a relatively long distance from the slot 908B is not caused to move as quickly back towards the slot.

As the crankshaft 904 rotates, the crankshaft and the connecting rods 905 transfer momentum to air and oil particles within the four bays 907 of the engine 104. In particular, as the lower ends of the connecting rods 905 sweep over the slots 908 in their lowest portion of their stroke, they affect the direction at which air and oil droplets pass through the slots 908 into the sump. (The direction in which the lower ends of the connecting rods 905 sweep over the slots 908 in the lowest part of their stroke is indicated by arrow 1002 in FIG. 10.)

In the case of the slots 908B, which have a longitudinal axis arranged parallel to the crankshaft 904, the momentum provided to the air and oil droplets by the crankshaft 904 and connecting rods 905 tends to force the air and oil droplets through the slots 908B in a direction that assists flow of oil along the outer chamber 205C towards the pickup chamber 206. This is not the case for slots 908A, 908C and 908D.

To assist flow of oil along the outer chambers 205A, 205B and 205D, the corresponding slots 908C, 908A and 908D are provided with a surface oriented to redirect air passing through those slots, along the respective outer chamber 205A, 205B and 205D to the pickup chamber 206. In the present embodiment, the surface is provided on a scoop 1003 positioned alongside each one of the slots 908C, 908A and 908D, within the respective outer chamber 205A, 205B and 205D as shown in FIG. 10. For example, as shown in FIG. 11, a scoop 1003C is positioned adjacent to each one of the slots 908C, and the scoops 1003C have a concave surface 1102 configured to deflect air entering the outer chamber 205A towards the gap 211 (shown in FIG. 10) between the baffles 204A and 204B.

In addition to being provided with scoops 1003, the slots 908A and 908D have a longitudinal axis that extends at an oblique angle to that of the slots 908B, in order to enable the desired redirection of the air by the respective scoops 1003A and 1003D.

The slots 908C are parallel to the slots 908B and to the axis of the crankshaft 904. However, the scoops 1003C positioned alongside the slots 908C are arranged to deflect airflows that enter the outer chamber 205A from a first direction, which has a component directed away from the gap 211 between baffles 204A and 204B, to a second direction that has a component directed towards that gap 211.

In the present embodiment, the scoops 1003 form a part of the windage tray that provides the cover wall 402 of the sump 102.

An alternative oil sump 102A embodying the present invention is shown in cross-section in FIG. 12. The oil sump 102A is identical to the oil sump 102 of FIG. 11 but differs in that it includes an inlet 1201 of an air pickup tube 1202 positioned within the pickup chamber 206 of the oil sump 102A. The inlet 1201 is positioned near to the middle of the pickup chamber 206 towards the cover wall 402 where the oil droplets have generally been removed from the air. The air pickup tube 1202 is connected, directly or indirectly, to a positive crankcase ventilation (PCV) valve.

In the embodiment of FIGS. 10 and 11, the engine 104 comprised four cylinders and the sump 102 comprised a corresponding number (four) of outer chambers 205. However, in another alternative embodiment, an engine comprises just three cylinders; the sump is divided by baffles into three outer chambers and a pickup chamber; and slots are provided in a cover wall of the sump to enable bay-to-bay breathing via the outer chambers and the pickup chamber. In other alternative embodiments, engines have more than four cylinders and a corresponding number of outer chambers in the sump. For example, in one embodiment the engine has six cylinders and the sump has six baffles dividing the sump into six outer chambers and a pickup chamber.

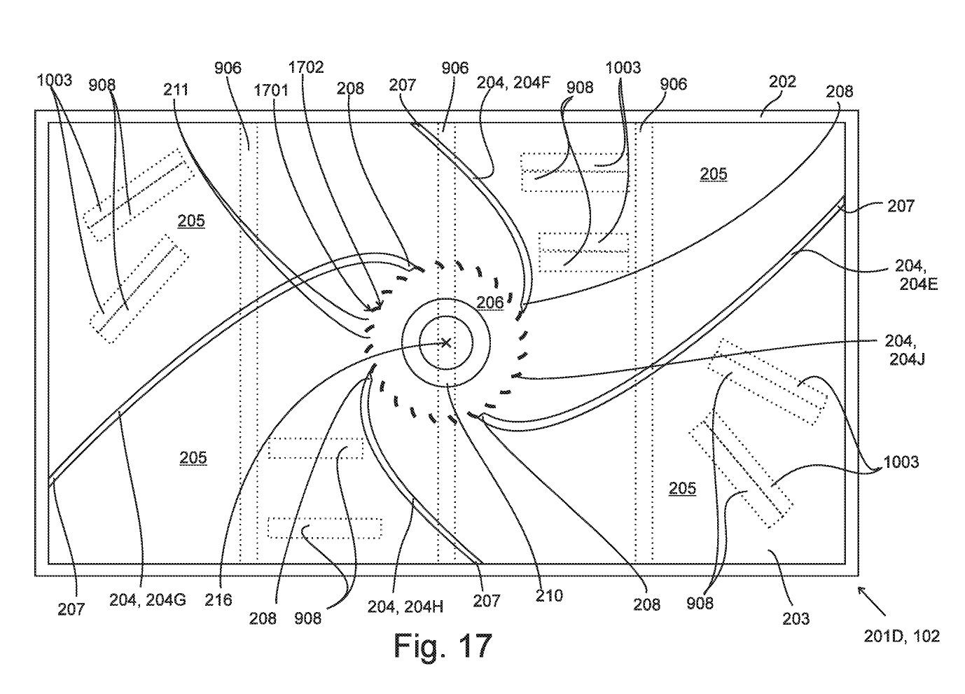

Another alternative container 201D embodying the present invention, for containing a liquid within a vehicle 101, is shown in a cross-sectional plan view in FIG. 17. Like the container 201 of FIGS. 2 and 3, the container 201D comprises a lower wall 203 and an outer wall 202 extending up from the lower wall 203 to contain a liquid. The container 201D also includes a plurality of baffles 204 configured to direct flow of liquid within the container 201D. The baffles 204 define a pickup chamber 206 having a vertical axis 216 (extending into the page in FIG. 17) and define four outer chambers 205 positioned adjacent to the pickup chamber 206. A liquid outlet 210 is positioned within the pickup chamber 206 for enabling liquid to be drawn from the container 201D.

Each one of a first plurality of the baffles 204 extends from a respective first position 207 to a respective second position 208 that is adjacent to the pickup chamber 206. The first position 207 of each one of the first plurality of baffles 204 is closer to the outer wall 202 than the respective second position 208. For example, in the present embodiment, four of the baffles 204E, 204F, 204G and 204H extend from the outer wall 202 to the pickup chamber 206.

A second plurality of the baffles 204, which are labelled 204J in FIG. 17, form a ring of vertical louvres surrounding the pickup chamber 206. The baffles 204J are arranged on a circle that divides the pickup chamber 206 from the outer chambers 205. Each one of the second plurality of baffles 204J has an outer edge 1701 and an inner edge 1702 that is closer to the vertical axis 216 than the respective outer edge 1701. Each one of the second plurality of baffles 204J is angled so that they extend from their outer edges 1701 to their inner edges 1702 in the same rotational direction around the axis 216 of the pickup chamber 206. Consequently, the second plurality of baffles 204J provide a directing means for causing fluid flowing from each of the outer chambers 205 to flow around the axis 216 of the pickup chamber 206.

In the present embodiment, the second plurality of baffles 204J comprises 24 baffles 204J that are arranged in a ring adjacent to the second positions 208 of the baffles 204E, 204F, 204G and 204H. The second plurality of baffles 204J define five respective gaps 211 for each of the outer chambers 205 to allow liquid flow from each outer chamber 205 through the respective gaps 211 into the pickup chamber 206. However, in alternative embodiments fewer than, or more than, 24 baffles 204J are provided. For example, in one embodiment the container comprises just three outer chambers 205 defined by a respect three first baffles 204, and a respective additional second baffle 204 is positioned between each pair of the first baffles to direct fluid, which flows from the outer chambers 205 into the pickup chamber 206, around the axis 216 of the pickup chamber 206.

The arrangement of first baffles 204E, 204F, 204G and 204H and second baffles 204J as shown in FIG. 17 may be used within a fuel tank 103, a urea tank 105 or a coolant tank 106. However, in the present embodiment, the container 201D of FIG. 17 is an oil sump 102 for an internal combustion engine 104. As described with respect to the sump 102 of FIG. 10, the container 201D has a cover wall (not shown in FIG. 17) and one of more slots (whose positions are shown in dashed outline 908) provided in the cover wall at the lower end of each of four bays of the engine. The positions of internal walls 906 of the engine 104 that separate its bays are also shown in FIG. 17.

To assist flow of oil along the outer chambers 205, the corresponding slots 908 are provided with a surface oriented to redirect air passing through those slots, along the respective outer chamber 205 to the pickup chamber 206. In the present embodiment, the surface is provided on a scoop 1003 positioned alongside each one of the slots 908, within the respective outer chamber 205 in a similar manner to that described above with regard to FIGS. 10 and 11.

It will be understood that the oil sump 102 of FIG. 17 is able to operate in a similar manner to that described above for the oil sump 102 of FIGS. 9, 10 and 11. Thus, during operation of the engine 101, air is pumped from the bays of the engine backwards and forwards through the outer chambers 205 and pickup chamber 206 of the sump 102 resulting in a vortex of fluid within the pickup chamber 206. Also, as described above with regard to FIGS. 13 and 14, the vortex causes separation of oil particles from the air and causes separation of air from the bulk of the oil in the pickup chamber 206.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A container for containing a liquid within a vehicle, the container comprising:
an outer wall configured to contain the liquid;
a plurality of baffles configured to direct flow of the liquid within the container, the plurality of baffles defining a pickup chamber, at least three outer chambers positioned adjacent to the pickup chamber and at least one respective gap for each said at least three outer chambers to allow liquid flow from each of the at least three outer chambers through the at least one respective gap into the pickup chamber; and
a directing means configured to cause liquid flowing from each of the at least three outer chambers to flow around a vertical axis within the pickup chamber.

2. The container of claim 1, wherein the directing means is configured to cause the liquid flowing from each of the at least three outer chambers to flow around the vertical axis within the pickup chamber in the same rotational direction.

3. The container of claim 1, wherein the directing means comprises at least three of the plurality of baffles.

4. The container of claim 1, wherein the plurality of baffles includes a first plurality of baffles and a second plurality of baffles, wherein at least a portion of each one of the first plurality of baffles extends from a respective first position that is adjacent to the outer wall to a respective second position; the first position of each one of the first plurality of baffles is closer to the outer wall than the respective second position; and the directing means comprises at least a portion of each one of the second plurality of baffles, which extend around the pickup chamber in the same rotational direction.

5. The container of claim 4, wherein each one of the second plurality of baffles is different from each one of the first plurality of baffles; and the second plurality of baffles form a ring of louvres surrounding the pickup chamber.

6. The container of claim 1, wherein the plurality of baffles includes a first plurality of baffles, wherein at least a first portion of each one of the first plurality of baffles extends from a respective first position to a respective second position that is adjacent to the pickup chamber; the respective first positions are closer to the outer wall than the respective second positions; the directing means comprises a second portion of each one of the first plurality of baffles; and said second portions of each of the first plurality of baffles extend around the pickup chamber in the same rotational direction.

7. The container of claim 1, wherein each of the at least one respective gaps is positioned relative to the pickup chamber to provide a course through the at least one respective gap to one side of the vertical axis.

8. An internal combustion engine comprising the container of claim 1.

9. A vehicle comprising the container of claim 1.

10. A method of directing flow of liquid contained within a container of a vehicle, wherein the container comprises a plurality of baffles configured to direct flow of the liquid within the container, the plurality of baffles defining a pickup chamber, at least three outer chambers positioned adjacent to the pickup chamber and at least one respective gap for each of the at least three outer chambers to allow liquid flow from each of the at least three outer chambers through the at least one respective gap into the pickup chamber, the method comprising:
causing liquid to flow alongside at least one of the plurality of baffles from at least one of the at least three outer chambers of the container into the pickup chamber;
directing liquid flowing from at least one of the at least three outer chambers around a vertical axis of the pickup chamber; and
pumping the liquid from the pickup chamber.

11. An oil sump for an internal combustion engine comprising:
a plurality of baffles configured to direct a flow of oil within the oil sump, the plurality of baffles defining a plurality of outer chambers and a pickup chamber; and
a cover wall comprising a plurality of slots for enabling a flow of air and oil into the oil sump;
wherein the plurality of slots are positioned to enable an airflow into each one of the plurality of outer chambers and at least one of the plurality of slots is provided with a surface configured to redirect the airflow along a respective outer chamber of the plurality of outer chambers to the pickup chamber.

12. The oil sump of claim 11, wherein
the at least one of the plurality of slots is provided with a respective scoop providing the surface for redirecting the airflow passing through said at least one of the plurality of slots;
the at least one of the plurality of slots includes a first slot and a second slot;
the first slot has a longitudinal axis extending along a first direction; and
the second slot has a longitudinal axis extending along a second direction at an oblique angle to the first direction.

13. The oil sump of claim 11, wherein a respective gap is provided between neighboring baffles of the plurality of baffles to allow a flow of oil from each of the plurality of outer chambers to the pickup chamber, wherein each respective gap is positioned to cause a rotating flow of air or oil around the pickup chamber.

14. The oil sump of claim 11, wherein a directing means is configured to cause air or oil flowing from each of the plurality of outer chambers into the pickup chamber to flow around a vertical axis within the pickup chamber in the same rotational direction.

15. The oil sump of claim 14, wherein the directing means comprises a first plurality of the plurality of baffles.

16. The oil sump of claim 14, wherein the directing means comprises at least a portion of at least some of the plurality of baffles, and each said portion extends around the pickup chamber in the same rotational direction.

17. The oil sump of claim 11, further including an outer wall and wherein the plurality of baffles includes a first plurality of baffles;
each one of the first plurality of baffles extends from a respective first position to a respective second position;
the respective first positions are closer to the outer wall than the respective second positions; and
at the respective second positions the first plurality of baffles extend around the pickup chamber in the same rotational direction.

18. An internal combustion engine comprising the oil sump of claim 11.

19. A vehicle comprising the internal combustion engine of claim 18.

20. A method of directing a flow of oil through an oil sump comprising:
enabling air and oil to flow into each one of a plurality of outer chambers of the oil sump via slots, the outer chambers being defined by baffles;
enabling the air and oil to flow from the outer chambers to a pickup chamber of the oil sump; and
pumping oil from the pickup chamber, wherein air passing through at least one of the slots is redirected by a surface to assist a flow of oil in a corresponding outer chamber towards the pickup chamber.
